(19) United States
(12) Patent Application Publication
(10) Pub. No.: US 2019/0057197 A1
(43) Pub. Date: Feb. 21, 2019

(54) TEMPORAL ANOMALY DETECTION SYSTEM AND METHOD

(71) Applicant: Cognant LLC, Mountain View, CA (US)

(72) Inventors: Heng Wang, San Jose, CA (US); Bhargav Bhushanam, Mountain View, CA (US); Arun Kejariwal, Fremont, CA (US); James Koh, Mountain View, CA (US); Matt Holland, Palo Alto, CA (US); Ishan Upadhyaya, San Carlos, CA (US); Daniel Lopez, San Jose, CA (US)

(21) Appl. No.: 16/032,402

(22) Filed: Jul. 11, 2018

Related U.S. Application Data
(60) Provisional application No. 62/545,621, filed on Aug. 15, 2017.

(51) Int. Cl. G06F 21/12; H04L 29/06; H04L 29/08; G06F 17/30

(52) U.S. Cl. CPC G06F 21/128; G06F 17/3089; H04L 67/22; H04L 63/1425

(57) ABSTRACT

A method, a system, and an article are provided for detecting and managing anomalies associated with content presentations. An example computer-implemented method can include: obtaining data including a history of content presentations by a plurality of publishers on a plurality of client devices; calculating a plurality of performance indicators for each publisher based on the data, the performance indicators providing a measure of user interactions with the content presented by the publisher; generating a time history of each performance indicator for each of a plurality of time periods; selecting, for each time history, at least one anomaly detector from a plurality of anomaly detectors; detecting an anomaly in at least one time history using the selected at least one anomaly detector; and based on the detected anomaly, facilitating an adjustment of content presentations by the plurality of publishers.

### CROSS-REFERENCE TO RELATED APPLICATIONS

This application claims the benefit of U.S. Provisional Patent Application No. 62/545,621, filed Aug. 15, 2017, the entire contents of which are incorporated by reference herein.

### BACKGROUND

The present disclosure relates generally to anomaly detection and, in certain examples, to systems and methods for detecting and managing anomalies associated with digital content presentations.

In general, client devices are capable of presenting a wide variety of content, including images, video, audio, and combinations thereof. Such content can be stored locally on client devices and/or can be sent to the client devices from server computers over a network (e.g., the Internet). To watch an online movie, for example, a user of a client device can download a copy of the movie and/or can stream the movie from a content provider. Online content can be provided to client devices by publishers, such as websites and software applications.

Users can interact with content in various ways. A user can, for example, view images, listen to music, or play computer games. With certain online content, a user can select the content or a portion thereof and be directed to a website where further content can be presented or obtained. In some instances, users can download or receive content in the form of software applications.

### SUMMARY

In general, the subject matter of this disclosure relates to detecting and managing anomalies related to presentations of digital content and user interactions with the digital content on client devices. A group of publishers can be used to present content on the client devices. Data related to the content presentations can be collected and used to calculate key performance indicators (KPIs) for each publisher. The KPIs can provide a measure of user interaction with the content presented by the publisher. A collection of temporal streams or time series can be generated for each KPI, with each KPI representing a different time period. The temporal streams can then be analyzed using a collection of anomaly detectors (also referred to herein as anomaly detection algorithms), which can compare the temporal streams to predicted baselines. Deviations between the temporal streams and the predicted baselines can be used to identify anomalies in the temporal streams and the associated KPIs. Based on the detected anomalies, adjustments can be made to future presentations of the content. For example, when an anomaly indicates that a publisher has engaged in fraudulent activity, the publisher can be put on a blacklist to prevent the publisher from being able to present content in the future. Additionally or alternatively, when an anomaly indicates that users have an affinity for a particular publisher, the publisher can be given a larger volume of content to present, going forward.

Advantageously, the anomaly detection systems and methods described herein can leverage novel algorithms and/or big data platforms to extract actionable insights and help content users, buyers, publishers, or distributors take action in the event of unexpected or anomalous behavior. The algorithmic-based approach described herein is particularly important and valuable, given a tendency of KPI and temporal streams to evolve over time and a consequent need for anomaly detection processes to be auto-adaptive. More particularly, the approach described herein is directed to a temporal anomaly detection architecture that can make use of dynamic and robust anomaly detection algorithms. The approach can provide a modular and extensible framework that can make use of batch processing to surface abnormal deviations of performance related metrics in a timely manner. The use of multiple anomaly detection algorithms, preferably configured in multiple layers or in a sequence, provides a robust detection scheme that is able to distinguish true anomalies from false positives.

Advantageously, the systems and methods described herein can achieve an improved ability to detect and diagnose publisher behavior related to the presentation of content. By generating temporal streams of KPI data at different time granularities, the approach described herein can detect a wide variety of anomalies that occur at different frequencies or over different time intervals. Additionally or alternatively, use of multiple detection algorithms on the temporal streams can greatly improve detection accuracy and efficiency. In general, the approach represents a substantial improvement in the ability of a computer to detect anomalies, particularly anomalies associated with content presentations and user interactions with the content.

In one aspect, the subject matter described in this specification relates to a computer-implemented method. The method includes: obtaining data including a history of content presentations by a plurality of publishers on a plurality of client devices; calculating a plurality of performance indicators for each publisher based on the data, the performance indicators including a measure of user interactions with the content presented by the publisher; generating a time history of each performance indicator for each of a plurality of time periods; selecting, for each time history, at least one anomaly detector from a plurality of anomaly detectors; detecting an anomaly in at least one time history using the selected at least one anomaly detector; and based on the detected anomaly, facilitating an adjustment of content presentations by the plurality of publishers.

In certain examples, each publisher can be or include at least one of a website and a software application. The content can be or include an image, a video, audio, a computer game, and any combination thereof. The performance indicators can include at least one of a number of content presentations, a number of clicks on the content presentations, a number of software application installations related to the content presentations, and a click-to-install ratio. The time periods can be or include an hour, a day, and/or a week.

In some implementations, detecting the anomaly can include: determining a baseline for the at least one time history; and determining a difference between the at least one time history and the baseline. Detecting the anomaly can include determining that the at least one time history includes a statistically significant deviation. The anomaly can be or include fraud. Facilitating the adjustment can include revoking an authorization for at least one publisher to present content. Facilitating the adjustment can include adjusting a volume of content presented by at least one publisher.

In another aspect, the subject matter described in this specification relates to a system having one or more computer processors programmed to perform operations including: obtaining data including a history of content presentations by a plurality of publishers on a plurality of client devices; calculating a plurality of performance indicators for each publisher based on the data, the performance indicators including a measure of user interactions with the content presented by the publisher; generating a time history of each performance indicator for each of a plurality of time periods; selecting, for each time history, at least one anomaly detector from a plurality of anomaly detectors; detecting an anomaly in at least one time history using the selected at least one anomaly detector; and based on the detected anomaly, facilitating an adjustment of content presentations by the plurality of publishers.

In some instances, each publisher can be or include at least one of a website and a software application. The content can be or include an image, a video, audio, a computer game, and any combination thereof. The performance indicators can include at least one of a number of content presentations, a number of clicks on the content presentations, a number of software application installations related to the content presentations, and a click-to-install ratio. The time periods can be or include an hour, a day, and/or a week.

In various examples, detecting the anomaly can include: determining a baseline for the at least one time history; and determining a difference between the at least one time history and the baseline. Detecting the anomaly can include determining that the at least one time history includes a statistically significant deviation. The anomaly can be or include fraud. Facilitating the adjustment can include revoking an authorization for at least one publisher to present content. Facilitating the adjustment can include adjusting a volume of content presented by at least one publisher.

In another aspect the subject matter described in this specification relates to an article. The article includes a non-transitory computer-readable medium having instructions stored thereon that, when executed by one or more computer processors, cause the computer processors to perform operations including: obtaining data including a history of content presentations by a plurality of publishers on a plurality of client devices; calculating a plurality of performance indicators for each publisher based on the data, the performance indicators including a measure of user interactions with the content presented by the publisher; generating a time history of each performance indicator for each of a plurality of time periods; selecting, for each time history, at least one anomaly detector from a plurality of anomaly detectors; detecting an anomaly in at least one time history using the selected at least one anomaly detector; and based on the detected anomaly, facilitating an adjustment of content presentations by the plurality of publishers.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for detecting and managing anomalies associated with digital content presentations.

FIG. 2 is a schematic data flow diagram of an example system for detecting and managing anomalies associated with digital content presentations.

FIG. 3 is a flowchart of an example method of using a processing module to preprocess data related to digital content presentations.

FIG. 4 is a plot of an example performance indicator during a period of time.

FIG. 5 is a flowchart of an example method of using an anomaly detection module to detect anomalies in a temporal data stream.

FIG. 6 is a plot of an example performance indicator and a baseline during a period of time.

FIG. 7 is a flowchart of an example method of detecting and managing anomalies associated with digital content presentations.

### DETAILED DESCRIPTION

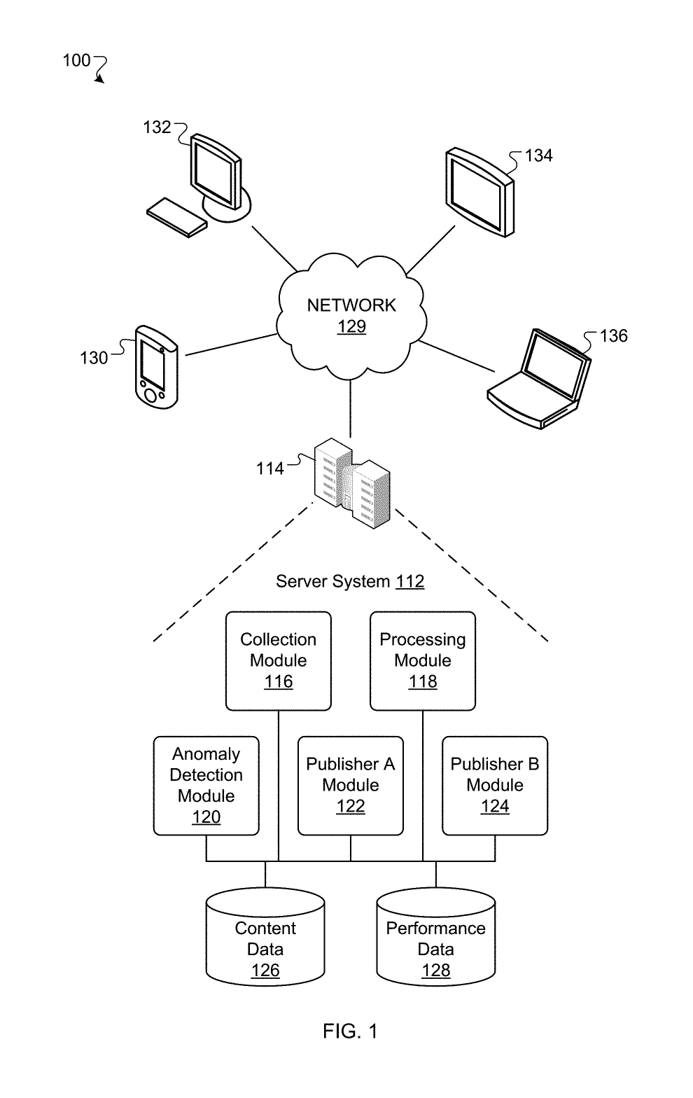

FIG. 1 illustrates an example system 100 for detecting and managing anomalies associated with digital content presentations. A server system 112 provides functionality for collecting and processing data streams associated with the digital content, and for detecting anomalies present in the data streams. The server system 112 includes software components and databases that can be deployed at one or more data centers 114 in one or more geographic locations, for example. In certain instances, the server system 112 is, includes, or utilizes a content delivery network (CDN). The server system 112 software components can include a collection module 116, a processing module 118, an anomaly detection module 120, a publisher A module 122, and a publisher B module 124. The software components can include subcomponents that can execute on the same or on different individual data processing apparatus. The server system 112 databases can include a content data 126 database and a performance data 128 database. The databases can reside in one or more physical storage systems. The software components and data will be further described below.

An application, such as, for example, a web-based application, can be provided as an end-user application to allow users to interact with the server system 112. The client application or components thereof can be accessed through a network 129 (e.g., the Internet) by users of client devices, such as a smart phone 130, a personal computer 132, a tablet computer 134, and a laptop computer 136. Other client devices are possible. In alternative examples, the content data 126 database, the performance data 128 database, or any portions thereof can be stored on one or more client devices. Additionally or alternatively, software components for the system 100 (e.g., the collection module 116, the processing module 118, the anomaly detection module 120, the publisher A module 122, and/or the publisher B module 124) or any portions thereof can reside on or be used to perform operations on one or more client devices.

FIG. 1 depicts the collection module 116, the processing module 118, and the anomaly detection module 120 as being able to communicate with the content data 126 database and the performance data 128 database. The content data 126 database generally includes digital content that can be presented on the client devices. The digital content can be or include, for example, images, videos, audio, computer games, text, messages, offers, and any combination thereof. The performance data 122 database generally includes information related to the presentation of digital content on the client devices and any interactions with the digital content by users of the client devices. Such information can include, for example, a history of user interactions with the digital content, including a record of the types of user interactions (e.g., viewing, selecting, clicking, playing, installing, etc.) and the times at which such user interactions occurred (e.g., time and date).

In general, the digital content (e.g., from the content data 126 database) can be presented on the client devices using a plurality of publishers, which can include the publisher A module 122 and the publisher B module 124. Each publisher can be or include, for example, a website and/or a software application configured to present the content. When an item of content is presented on a client device, the user can interact with the content in multiple ways. For example, the user can view the content, select or click one or more portions of the content, play a game associated with the content, and/or take an action associated with the content. In certain instances, the action can be or include, for example, watching a video, viewing one or more images, selecting an item (e.g., a link) in the content, playing a game, visiting a website, downloading additional content, and/or installing a software application. In some instances, the content can offer the user a reward in exchange for taking the action. The reward can be or include, for example, a credit to an account, a virtual item or object for an online computer game, free content, or a free software application. Other types of rewards are possible.

Additionally or alternatively, in some instances, the publishers can be rewarded based on actions taken by users in response to the displayed content. For example, when a user selects an item of content or takes a certain action in response to the content, the publisher can receive a reward or compensation from an entity (e.g., a person or a company) associated with the content or the action. The reward or compensation can provide an incentive for the publisher to display the content.

In some instances, for example, a publisher can receive compensation when it presents an item of content on a client device and a user installs a software application (or takes a different action) in response to the content. The publisher can provide information to the collection module 116 indicating that the content was presented on the client device. Alternatively or additionally, the collection module 116 can receive an indication that the user selected the content and/or that the software application was installed. Based on the received information, the collection module 116 can attribute the software application installation to the item of content presented by the publisher. The publisher can receive the compensation based on this attribution.

In various examples, the collection module 116 can be or include an attribution service provider. The attribution service provider can receive information from publishers related to the presentation of content and user actions in response to the content. The attribution service provider can determine, based on the information received, how to attribute the user actions to individual publishers. In some instances, for example, a user can visit or use websites or software applications provided by publishers that present an item of content at different times on the user's client device. When the user takes an action (e.g., installs a software application) in response to the content presentations, the attribution service provider may select one of the publishers to receive the credit or attribution for the action. The selected publisher may be, for example, the publisher that was last to present the content before the user took the action. The selected publisher can receive compensation from an entity associated with the content or the action. Other publishers that presented the item of content may receive no such compensation.

This scheme in which publishers can receive compensation based on attribution for user actions can result in fraudulent publisher activity. For example, a fraudulent publisher can send incorrect or misleading information to the collection module 116 (or attribution server provider) in an effort to fool the collection module 116 into attributing user action to content presented by the publisher. The fraudulent publisher can, for example, provide information to the collection module 116 indicating that the content was displayed on the user's client device when the content was not in fact displayed. Additionally or alternatively, the fraudulent publisher can provide information to the collection module 116 indicating that the user interacted with the content (e.g., selected or clicked the content) when such interactions did not occur. Based on this incorrect information, the collection module 116 (or attribution service provider) can erroneously attribute user action (e.g., a software application installation) to the fraudulent publisher, which may be rewarded (e.g., with money) for its deceitful activity.

In various examples, the system 100 can detect fraudulent publisher activity by calculating and analyzing various key performance indicators (KPIs) related to publishers and publisher content presentations. The KPIs can be calculated based on information received from publishers by the collection module 116. The KPIs can be or include, for example, a number of content presentations (also referred to as impressions), a number of content selections (also referred to as clicks), a number of engagements with a software application, a number of software application installs, a number of conversions (e.g., purchases or offer acceptances), and/or any combination thereof. Other KPIs are possible. For example, certain derived metrics can be used as KPIs for a game application. Such KPIs can include, for example, a rate of player advancement in a game, a percentage of users who change or drop one or more levels in the game, and/or a percentage of users who make purchases in the game. In some instances, a ratio, product, sum, or difference of two or more KPIs can be informative, such as a ratio of the number of clicks to the number of content presentations (referred to as click-through rate), or the ratio of the number of clicks to the number of installs (referred to as click-to-install ratio). Each KPI is typically calculated for a period of time, such as a previous hour, day, or week. The KPIs can be updated or recalculated as additional information is collected over time.

In a typical instance, publisher performance can be evaluated and/or publisher fraudulent activity can be identified by detecting anomalies in one or more KPIs. Such anomalies can be caused by a wide variety of factors. For example, when a frequency at which an item of content is presented increases, a corresponding increase in KPIs related to content presentations and/or content clicks can occur. Additionally or alternatively, when a publisher attempts to drive a high number of clicks through fraudulent means (e.g., bots) in an effort to win attribution illegitimately, such efforts can show up as spikes in click volume. In some instances, when an appealing new item of content is presented, a large number of users can interact with the content or take action (e.g., installing an application) based on the content. In another example, data losses can prevent the collection module 116 from receiving certain portions of publisher data, which can result in KPI anomalies.

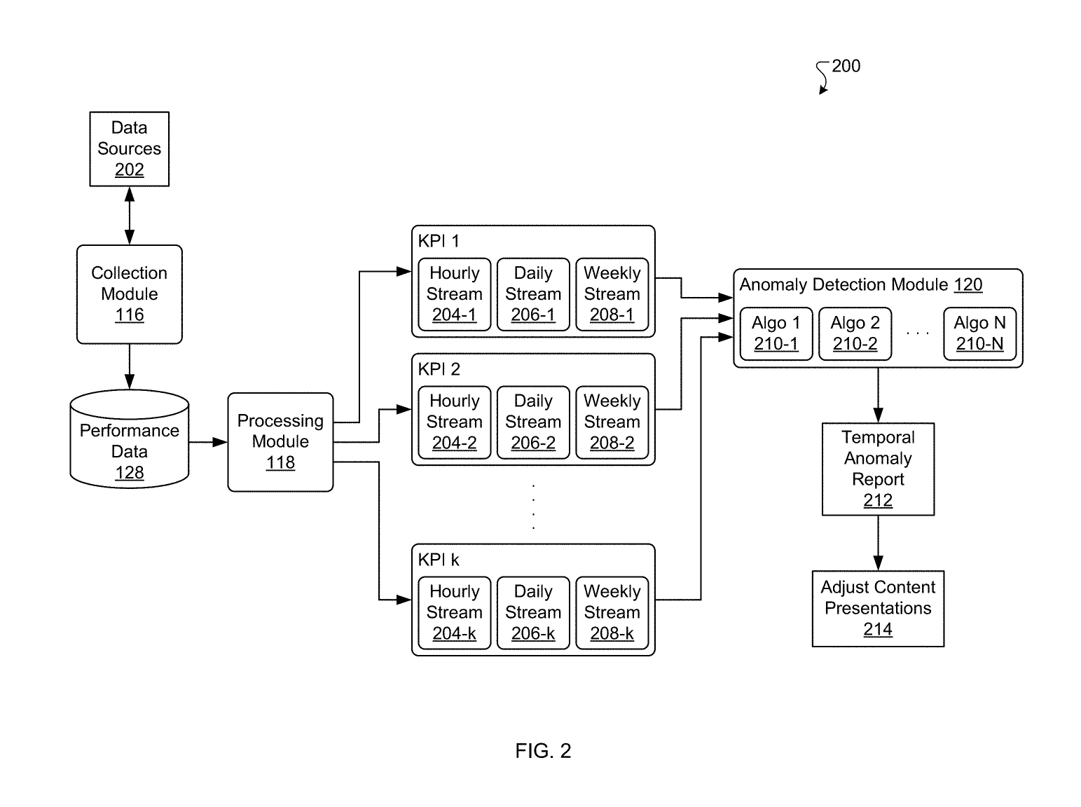

Referring to FIG. 2, in various examples, a system 200 for detecting KPI anomalies includes the collection module 116, the processing module 118, and the anomaly detection module 120. The collection module 116 receives source data related to content presentations and user interactions with the content (e.g., clicks and application installs) from one or more data sources 202. The data sources 202 can be or include one or more publishers, such as the publisher A module 122 and the publisher B module 124. The source data can be stored in the performance data 128 database.

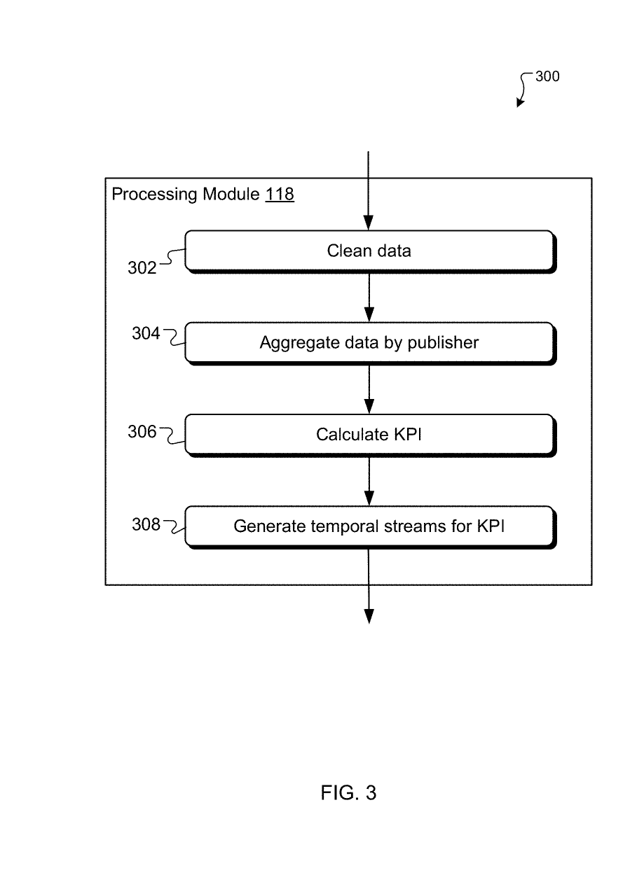

Also referring to FIG. 3, the source data can be provided to the processing module 118, which can perform one or more data processing operations 300. The data processing operations 300 can include, for example, cleaning (step 302) the source data to remove any erroneous data or handle any missing or inaccurate data. Additionally or alternatively, the data processing operations can include aggregating (step 304) the data by publisher, such that data for each individual publisher can be extracted from the source data and/or separated from other source data. Next, the processing module 118 can calculate (step 306) multiple KPIs for each publisher over a variety of time periods, such as one hour, one day, one week, and/or one month, although other suitable time periods are possible. The processing module 118 can generate (step 308) separate temporal streams of the calculated KPIs for each publisher. Each temporal stream can be or include, for example, a series of KPI values at different times during the time periods. A temporal stream can also be referred to herein as a time history or a time series.

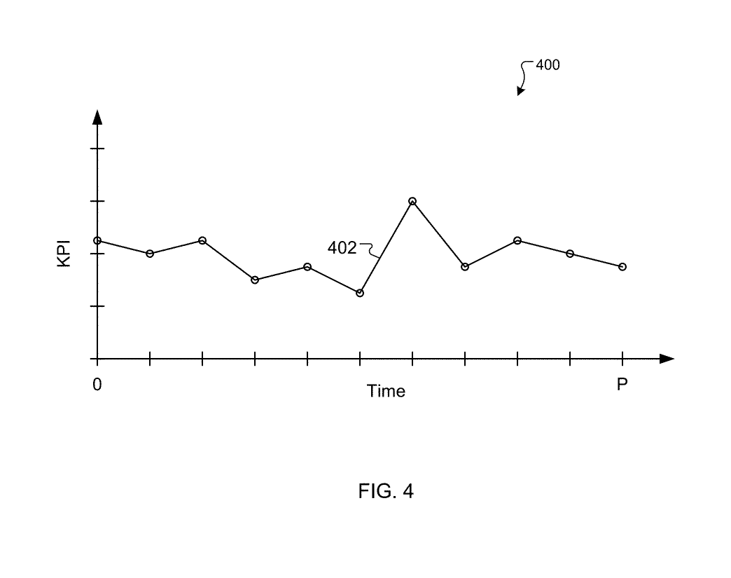

For example, FIG. 4 includes a plot 400 of a temporal stream 402 for a KPI (e.g., click-through rate or number of software application installs) during a time period P. The KPI in this example is depicted as varying or changing in value during the time period P. In alternative examples, the KPI can be constant or substantially constant (e.g., less than 5% variation) during the time period P.

In general, the processing module 118 can calculate any desired number of KPIs and generate temporal streams for each KPI at different time granularities or time periods. For example, referring again to FIG. 2, the processing module 118 can calculate k KPIs (e.g., KPI 1, KPI 2, . . . , and KPI k) for each publisher, where k is any positive integer. In preferred implementations, k is greater than or equal to two (e.g., 2, 3, 4, 5, or higher). For each of the k KPIs, the processing module 118 can create one or more temporal streams for different time periods. For example, for KPI 1, the processing module 118 can create an hourly stream 204-1, a daily stream 206-1, and a weekly stream 208-1 that include temporal streams for KPI 1 for time periods lasting one hour, one day, and one week, respectively. Temporal streams for different time periods, such as one minute or one month, can be used. Likewise, for KPI 2 to KPI k, the processing module 118 can create hourly streams 204-2 to 204-k, daily streams 206-2 to 206-k, and weekly streams 208-2 to 208-k.

In various examples, a desired time granularity or time period for a stream can be determined based on a context of the stream and, in some cases, based on an amount of KPI variation in the stream. For example, when the stream includes KPI data related to impressions, clicks, installs, or other KPIs that can have significant high frequency variation, then granularities at hourly, daily, and weekly time periods can be used. Other streams of KPI data that are more stable (e.g., less variation or lower frequency variation over time) can be evaluated at longer granularities, such as, for example, weekly, biweekly, monthly, or longer time periods. Examples of KPIs that are more stable can include, for example, click-through rate, click-to-install ratio, payer percentage (e.g., percent of users who make purchases), and/or install rate per 1000 impressions. In some instances, the desired granularity can be determined based on both KPI variation frequency and usage. For example, click-to-install ratio can be relatively stable, such that anomaly detection may not be necessary for short time intervals (e.g., one day). Over longer time intervals (e.g., weeks or months), however, click-to-install ratio can change significantly, for example, as a market for a software application becomes saturated.

Each temporal stream can include any suitable number of data points. In some instances, for example, a temporal stream can include 1, 5, 10, 100, 1000, or more data points. A temporal stream representing one hour can include, for example, one data point per minute, for a total of 60 data points. A temporal stream representing one day can include, for example, one data point per hour, for a total of 24 data points. Other numbers of data points can be used. The data points can be evenly spaced or unevenly spaced within a temporal stream.

In general, the use of temporal streams having different time granularities or time periods can allow a wide range of KPI variations to be analyzed, including volatile or high frequency variations (e.g., multiple oscillations or cycles per hour or day) and long term variations or trends (e.g., low frequency variations that occur over multiple days or weeks). High frequency variations, for example, can be more accurately detected or resolved using temporal streams of shorter duration. Additionally or alternatively, low frequency variations can be more accurately detected or resolved using temporal streams of longer duration. The different time granularities can improve the ability of the systems and methods described herein to detect a large variety of anomalies that can occur over a wide range of frequencies and time durations.

Once created, the temporal streams for the various KPIs and time periods can be provided to the anomaly detection module 120, which can analyze the temporal streams using a collection of algorithms, such as SEASONAL HYBRID ESD, median absolute deviation (MAD), or other suitable algorithm(s), to detect abnormal deviations. In general, the algorithms can be configured to process temporal data, develop an acceptable band or range of new values (e.g., based on previous values), and provide alerts when a new value falls outside the acceptable band. The algorithms can be referred to herein as anomaly detection algorithms or as anomaly detectors.

In some examples, each algorithm can include a separate or distinct anomaly detection model, which can utilize, for example, suitable machine-learning techniques or the like. The algorithms can use or include, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests), neural networks, and/or learning vector quantization models. Other classifiers can be used.

While any suitable number of different algorithms can be used to process the temporal streams in the anomaly detection module 120, the number of algorithms used can depend on the kind of stream being processed. For example, a simple stream having little or no variation might be processed by only one algorithm, whereas a complicated stream having significant variation may need two or more algorithms. The algorithms can be chosen based on, for example, an amount of variation or volatility of the temporal stream. Higher volatility streams may require complex and/or multiple algorithms, while streams with low volatility can be handled with a single algorithm. In some instances, the algorithms can be chosen based on the KPI, a type of time series (sample rate and/or frequency), and/or the time granularity for the temporal stream. Additionally or alternatively, when a KPI time series or temporal stream is volatile, robust statistical algorithms can be used that are capable of handling outliers and/or smoothing the temporal stream.

In some implementations, the detection algorithms can be arranged in a plurality of layers. For example, a first layer of one or more detection algorithms can make an initial determination regarding the presence of any anomalies in a temporal stream. If the first layer determines there is little or no probability (e.g., less than 1% or 10%) of any anomalies, the analysis of the temporal stream can end with no anomalies detected. Otherwise, if the first layer determines a higher probability (e.g., greater than 1% or 10%) of anomalies, the temporal stream can be further analyzed with a second layer of one or more detection algorithms. Depending on the results from the second layer, the analysis can end or the temporal stream can be passed to one or more additional layers. In general, each layer can operate as a filter that either permits passage of the temporal stream (e.g., to a subsequent layer) or blocks the temporal stream from further passage. When any layer determines that the likelihood of an anomaly is low, for example, the analysis of the temporal stream can end. When the layer determines that the likelihood of an anomaly is higher, the temporal stream can be passed to a subsequent layer and/or a final determination can be made. In this way, any temporal streams that reach or pass through a final layer can be considered to include an anomaly. This can avoid the detection of false positives. In some instances, it can be easier for temporal streams to pass through initial layers, which can perform a coarse or initial screening, and more difficult to pass through subsequent layers, which can perform a more detailed or comprehensive analysis.

In the system 200 of FIG. 2, the anomaly detection module 120 is depicted as including N separate algorithms, including a first algorithm 210-1, a second algorithm 210-2, . . . , and an Nth algorithm 210-N. The number of available algorithms N can be any integer, preferably greater than or equal to two (e.g., 2, 3, 5, 10, 15, or more).

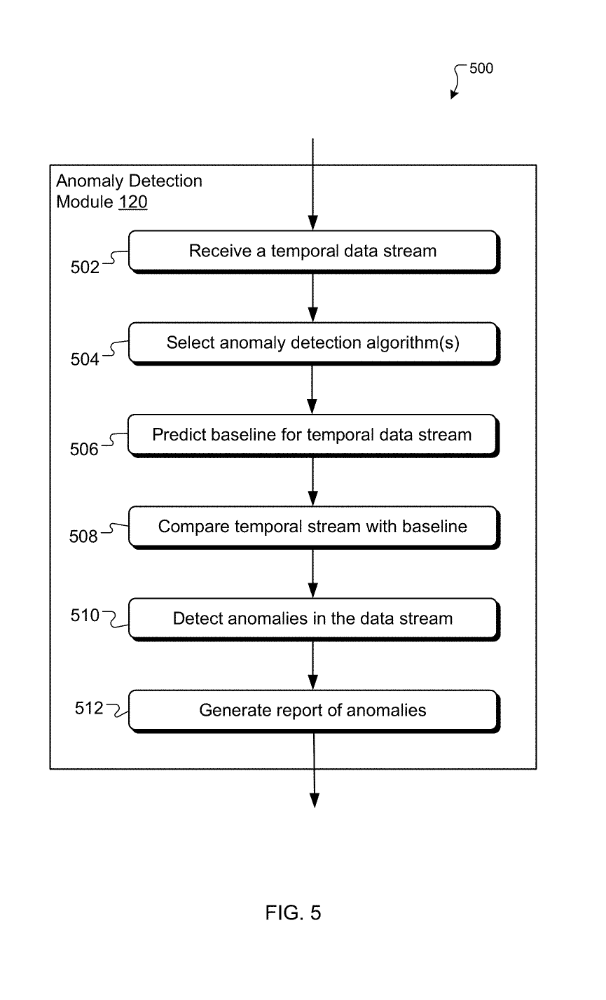

In preferred implementations, each temporal stream can be processed separately by one or more of the available algorithms in the anomaly detection module 120, and the algorithms can work together to detect abnormal deviations in KPI values. Referring to FIG. 5, in an example method 500, the anomaly detection module 120 can receive (step 502) one of the KPI temporal streams and, based on the type of stream (e.g., volatility), can select (step 504) one or more of the available algorithms. Each selected algorithm can predict (step 506) a baseline (e.g., a value or stream) and can compare (step 508) the temporal stream with the baseline. Based on the comparison, any anomalies in the temporal stream can be detected (step 510). An output file can be generated (step 512) based on the analysis results for each temporal stream and/or the results can be presented on a computer display for review. In one example, results in the output files can be aggregated by publisher in a single report. This can make it easier to attribute anomalous activity to one or more specific publishers. In a typical implementation, any anomalies in the temporal streams can be identified automatically and/or can be flagged for users of the anomaly detection module 120. Appropriate further action can be taken based on the analysis results, as described herein.

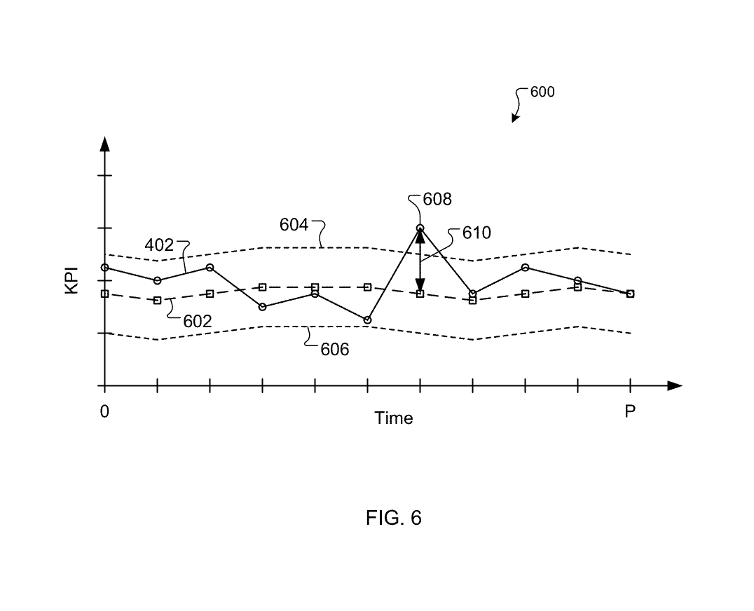

Referring to FIG. 6, a plot 600 includes the KPI temporal stream 402 (from FIG. 4) and a predicted baseline 602 for a KPI during the time period P. In general, the baseline 602 can be based on KPI data from a previous time period and can be generated using one or more of the algorithms used by the anomaly detection module 120. In one instance, for example, the baseline 602 can be or include a temporal stream from a preceding corresponding time period for the KPI (e.g., an immediately preceding time period). Alternatively or additionally, the baseline 602 can be or include an average (e.g., a weighted average) or a median of two or more temporal streams from preceding corresponding time periods for the KPI. In some instances, the baseline 602 can be determined by fitting one or more functional forms (e.g., lines, parabolas, sine waves, and any combination thereof) to one or more preceding temporal streams. The functional forms can then be used to predict the baseline 602 for the time period P.

The plot 600 also includes a maximum stream 604 and a minimum stream 606 that define upper and lower limits, respectively, on an acceptable band or range of values for the KPI temporal stream 402. In various examples, the maximum stream 604 and the minimum stream 606 can be determined based on one or more previous temporal streams for the KPI from one or more preceding time periods. For example, a standard deviation S can be determined for the one or more previous temporal streams. At any given time in the time period P, values for the maximum stream 604 and the minimum stream 606 can be, for example, a value from the baseline 602 plus and minus, respectively, the standard deviation S or any multiple (e.g., 2 or 3) or fraction (e.g., 0.5) of the standard deviation S. For example, if S=1 and the value of the baseline 602 at a given time is 5, then the corresponding values for the maximum stream 604 and the minimum stream 606 at that time can be 6 and 4, respectively. In this example, the values for the maximum stream 604 and the minimum stream 606 are the value of the baseline 602 (i.e., 5) plus and minus one standard deviation (i.e., 1), respectively. Other methods of determining the acceptable band or range of values for the KPI temporal stream 402 are possible. In some instances, for example, the standard deviation S can be replaced or represented by a deviation unit, which can be determined from

$$Deviation Unit = \frac{KPI - median}{MAD} , \qquad ( 1 )$$

where MAD=median(|Xᵢ−median|) and Xᵢ is the i^{th} value in the KPI temporal stream. In general, it is desirable for the acceptable band or range to be chosen such that any noteworthy deviations from the acceptable band are statistically significant.

In the depicted example, one point 608 on the temporal stream 402 falls outside of the acceptable range. A deviation 610, which comprises a difference between the point 608 and the baseline 602, is such that the baseline 602 plus the deviation 610 exceeds a corresponding value for the maximum stream 604. In this case, the point 608 can be considered to be an anomaly and/or the KPI for the temporal stream 402 can be considered to be or include an anomaly.

In various instances, not all of the N algorithms used by the anomaly detection module 120 are configured to detect anomalies by determining and using a baseline. At least some portion of the N algorithms can instead detect anomalies by looking for outliers within one or more temporal streams. For example, when a point or points in a temporal stream deviate significantly from other points in the stream (e.g., by more than one or two standard deviations from the average or median value), such deviations can be indicative of an anomaly, without making any comparisons to a baseline.

In general, the anomaly detection module 120 preferably utilizes a batch detection approach in which temporal streams can be analyzed one at a time. In some instances, for example, the anomaly detection module 120 can process the temporal streams for each publisher at regular time intervals (e.g., once per day). Statistical measures, such as median, median absolute deviation, and the like, can be used to develop a robust baseline and/or an acceptable range of values around the baseline. When a KPI temporal stream is statistically significantly deviated from the baseline, the temporal stream and/or its KPI can be identified as being or including an anomaly. Statistical tests, such as, for example, t-test, p-test, and so forth, can be used to define or identify deviations as being statistically significant.

Additionally or alternatively, the anomaly detection module 120 can achieve dynamic anomaly detection by taking into account variable factors, such as, for example, seasonality and trend, and/or by making use of dynamic thresholds to identify outliers, thereby reducing false positives. In general, a dynamic threshold or baseline can account for variations or changes that occur over time, for example, during an hour, a day, or a week. For example, application installs can tend to exhibit weekly seasonality in which a rate of installs can increase during weekends. In such cases, if static or constant thresholds are used, an alert may consistently be generated as a result of the increased installs occurring on weekends. By using dynamic thresholds, however, a baseline can be constructed that accounts for or predicts more installs on weekends. Proper construction of the baseline can avoid false positives in this manner.

In some examples, the anomaly detection module 120 can employ a multi-layered approach to identify temporal deviations in KPIs. For example, to identify deviations in click volume, scan statistics can first be employed in the anomaly detection module 120 to filter out publishers having insignificant deviations. This can be achieved, for example, by scanning the temporal streams for deviations from a baseline. Publishers identified as having small or insignificant deviations during the scan can be disregarded and/or may require no further analysis. The remaining publishers can then be analyzed using one or more predictive algorithms in the anomaly detection module 120, as described herein, to identify anomalous activity. In an hourly click time series, for example, one useful scan statistic is a maximum click volume over 24 hours in a day. When scan statistics are applied to the hourly click time series, daily scan statistics can be obtained and anomaly detection can be employed on a scan statistic time series, for example, as a first step or layer of detection.

Referring again to FIG. 2, the anomaly detection module 120 can generate a temporal anomaly report 212 based on the results obtained by the algorithms used by the anomaly detection module 120. The temporal anomaly report 212 can identify any anomalies in KPIs for the publishers (e.g., the publisher A module 122 and/or the publisher B module 124). Such anomalies can be further identified as representing fraudulent publisher activity. For example, when KPI values in one or more temporal streams for a publisher fall outside of acceptable ranges, the generated temporal anomaly report 212 can indicate that the publisher is likely to have engaged in fraudulent activity.

Several different actions can be taken, preferably automatically, in response to identified anomalies. When a publisher is identified to have engaged in fraudulent activity, for example, the publisher can be added to a blacklist and/or can be prevented from presenting content on client devices in the future. In some instances, the fraudulent activity can be brought to the publisher's attention and/or, if appropriate, the publisher can be required or requested to refund any rewards or compensation that it earned based on the fraudulent activity. Alternatively or additionally, when an anomaly is identified as being associated with positive (e.g., not fraudulent) publisher activity, such that a publisher is performing better than other publishers, the publisher can be used to present additional content or a higher volume of content in the future. In general, the anomaly detection module 120 can use the temporal stream analysis results to make decisions regarding how to use specific publishers to present content going forward. Publishers who are identified as performing well can be used more in the future, and publishers who are identified as performing poorly or fraudulently can be used less in the future or not at all.

In various implementations, to extract actionable insights from big data, it can be important in some examples to leverage big data technologies, so that there is sufficient support for processing large volumes of data. Examples of big data technologies that can be used with the systems and methods described herein include, but are not limited to, APACHE HIVE and APACHE SPARK. In general, APACHE HIVE is an open source data warehousing infrastructure built on top of HADOOP for providing data summarization, query, and analysis. APACHE HIVE can be used, for example, as part of the processing module 118. APACHE SPARK is, in general, an open source processing engine built around speed, ease of use, and sophisticated analytics. APACHE SPARK can be leveraged to detect abnormal deviations in a scalable manner. APACHE SPARK can be used, for example, as part of the anomaly detection module 120.

The systems and methods described herein are generally configured in a modular fashion, so that extending underlying algorithms to new sources and modifying or adding underlying algorithms can be done with minimal effort. This allows the anomaly detection systems and methods to be refined and updated, as needed, to analyze new or impactful KPIs in a swift and independent manner. Further, as additional novel algorithms are developed for the anomaly detection module and used to analyze existing or new KPIs, an overall capability and accuracy of the systems and methods can grow monotonically.

In various examples, the systems and methods described herein can generate and use a wide range of temporal streams to capture abnormalities in front end as well as back end metrics associated with content presentations. Each temporal stream can represent an event that occurs at some point before, during, or after content presentations. A multitude of such temporal streams can be tracked to provide a global picture, so that content presentations can be efficiently optimized.

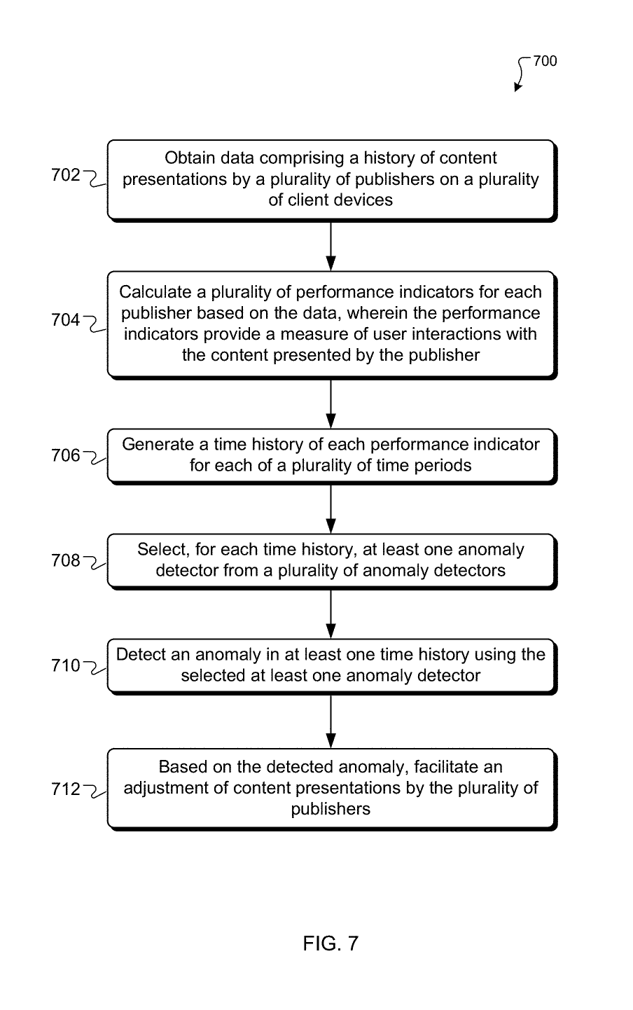

FIG. 7 illustrates an example computer-implemented method 700 of detecting and managing anomalies associated with content presentations. Data including a history of content presentations by a plurality of publishers on a plurality of client devices is obtained (step 702). A plurality of performance indicators are calculated (step 704) for each publisher based on the data. The performance indicators provide a measure of user interactions with the content presented by the publisher. A time history of each performance indicator is generated (step 706) for each of a plurality of time periods. For each time history, at least one anomaly detector is selected (step 708) from a plurality of anomaly detectors. An anomaly is detected (step 710) in at least one time history using the selected at least one anomaly detector. Based on the detected anomaly, an adjustment of content presentations by the plurality of publishers is facilitated (step 712).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method, comprising:
obtaining data comprising a history of content presentations by a plurality of publishers on a plurality of client devices;
calculating a plurality of performance indicators for each publisher based on the data, the performance indicators comprising a measure of user interactions with the content presented by the publisher;
generating a time history of each performance indicator for each of a plurality of time periods;
selecting, for each time history, at least one anomaly detector from a plurality of anomaly detectors;
detecting an anomaly in at least one time history using the selected at least one anomaly detector; and
based on the detected anomaly, facilitating an adjustment of content presentations by the plurality of publishers.

2. The method of claim 1, wherein each publisher comprises at least one of a website and a software application.

3. The method of claim 1, wherein the content comprises at least one of an image, a video, audio, a computer game, and any combination thereof.

4. The method of claim 1, wherein the performance indicators comprise at least one of a number of content presentations, a number of clicks on the content presentations, a number of software application installations related to the content presentations, and a click-to-install ratio.

5. The method of claim 1, wherein the time periods comprise at least one of an hour, a day, and a week.

6. The method of claim 1, wherein detecting the anomaly comprises:
determining a baseline for the at least one time history; and
determining a difference between the at least one time history and the baseline.

7. The method of claim 1, wherein detecting the anomaly comprises determining that the at least one time history comprises a statistically significant deviation.

8. The method of claim 1, wherein the anomaly comprises fraud.

9. The method of claim 1, wherein facilitating the adjustment comprises revoking an authorization for at least one publisher to present content.

10. The method of claim 1, wherein facilitating the adjustment comprises adjusting a volume of content presented by at least one publisher.

11. A system, comprising:
one or more computer processors programmed to perform operations comprising:
obtaining data comprising a history of content presentations by a plurality of publishers on a plurality of client devices;
calculating a plurality of performance indicators for each publisher based on the data, the performance indicators comprising a measure of user interactions with the content presented by the publisher;
generating a time history of each performance indicator for each of a plurality of time periods;
selecting, for each time history, at least one anomaly detector from a plurality of anomaly detectors;
detecting an anomaly in at least one time history using the selected at least one anomaly detector; and
based on the detected anomaly, facilitating an adjustment of content presentations by the plurality of publishers.

12. The system of claim 11, wherein each publisher comprises at least one of a website and a software application.

13. The system of claim 11, wherein the content comprises at least one of an image, a video, audio, a computer game, and any combination thereof.

14. The system of claim 11, wherein the performance indicators comprise at least one of a number of content presentations, a number of clicks on the content presentations, a number of software application installations related to the content presentations, and a click-to-install ratio.

15. The system of claim 11, wherein detecting the anomaly comprises:
determining a baseline for the at least one time history; and
determining a difference between the at least one time history and the baseline.

16. The system of claim 11, wherein detecting the anomaly comprises determining that the at least one time history comprises a statistically significant deviation.

17. The system of claim 11, wherein the anomaly comprises fraud.

18. The system of claim 11, wherein facilitating the adjustment comprises revoking an authorization for at least one publisher to present content.

19. The system of claim 11, wherein facilitating the adjustment comprises adjusting a volume of content presented by at least one publisher.

20. An article, comprising:
a non-transitory computer-readable medium having instructions stored thereon that, when executed by one or more computer processors, cause the computer processors to perform operations comprising:
obtaining data comprising a history of content presentations by a plurality of publishers on a plurality of client devices;
calculating a plurality of performance indicators for each publisher based on the data, the performance indicators comprising a measure of user interactions with the content presented by the publisher;
generating a time history of each performance indicator for each of a plurality of time periods;
selecting, for each time history, at least one anomaly detector from a plurality of anomaly detectors;
detecting an anomaly in at least one time history using the selected at least one anomaly detector; and
based on the detected anomaly, facilitating an adjustment of content presentations by the plurality of publishers.
